(19) United States
(12) Patent Application Publication
(10) Pub. No.: US 2017/0213649 A1
(43) Pub. Date: Jul. 27, 2017

(54) Multi-Layer Ceramic Electronic Component, Method of Producing the Same, and Ceramic Body

(71) Applicant: Taiyo Yuden Co., Ltd., Tokyo (JP)

(72) Inventors: Yoichi Kato, Tokyo (JP); Kotaro Mizuno, Tokyo (JP); Yukihiro Konishi, Tokyo (JP)

(21) Appl. No.: 15/393,959

(22) Filed: Dec. 29, 2016

(30) Foreign Application Priority Data
Jan. 26, 2016 (JP) 2016-012051

(51) Int. Cl. H01G 4/30; H01G 4/248; H01G 13/00; H01G 4/12; H01G 4/012

(52) U.S. Cl. CPC H01G 4/30; H01G 4/12; H01G 4/012; H01G 13/006; H01G 4/248

(57) ABSTRACT

A method of producing a multi-layer ceramic electronic component includes: preparing a multi-layer sheet including laminated ceramic sheets, and internal electrodes disposed between the ceramic sheets; cutting the multi-layer sheet to produce multi-layer chips each having side surfaces from which the internal electrodes are exposed; smoothing the side surfaces of the multi-layer chips; and providing side margins to the smoothed side surfaces of the multi-layer chips.

### CROSS REFERENCE TO RELATED APPLICATION

This application claims priority under 35 U.S.C. §119 to Japanese Patent Application No. 2016-012051, filed Jan. 26, 2016, which is hereby incorporated by reference in its entirety.

### BACKGROUND

The present invention relates to a multi-layer ceramic electronic component including side margins provided in a subsequent step, to a method of producing the multi-layer ceramic electronic component, and to a ceramic body.

Along with miniaturization and achievement of high performance of electronic devices, there have recently been increasingly strong demands for miniaturization and increase in capacity with respect to multi-layer ceramic capacitors used in the electronic devices. In order to meet those demands, it is effective to enlarge internal electrodes of the multi-layer ceramic capacitor. In order to enlarge the internal electrodes, it is necessary to thin side margins for ensuring insulation properties of the periphery of the internal electrodes.

Meanwhile, in a general method of producing a multi-layer ceramic capacitor, it is difficult to form side margins having a uniform thickness because of precision in each step (e.g., patterning of internal electrodes, cutting of a multi-layer sheet, etc.). Thus, in such a method of producing a multi-layer ceramic capacitor, as the side margins are made thinner, it is more difficult to ensure insulation properties of the periphery of the internal electrodes.

Japanese Patent Application Laid-open No. 2012-209539 discloses a technique of providing side margins in a subsequent step. in other words, this technique discloses that a multi-layer chip including internal electrodes exposed to side surfaces of the multi-layer chip is produced by cutting a multi-layer sheet, and side margins are then provided to the side surfaces of the multi-layer chip. This makes it possible to form side margins having a uniform thickness, and to ensure insulation properties of the periphery of the internal electrodes also when the side margins are made thinner.

### BRIEF SUMMARY

For cutting of the multi-layer sheet, cutting with use of a push-cutting blade, a rotary blade, or the like is widely performed. In this case, micro irregularities are generated on side surfaces of multi-layer chips after cutting. When side margins are formed on such side surfaces of the multi-layer chip, gaps are generated between the side surfaces of the multi-layer chip and the side margins. This leads to reduction in joint strength of the side margins to the multi-layer chip, and the side margins are easily peeled off from the multi-layer chip.

In view of the circumstances as described above, it is desirable to provide a multi-layer ceramic electronic component, a method of producing the multi-layer ceramic electronic component, and a ceramic body, which are capable of preventing side margins provided in a subsequent step from being peeled off.

According to an embodiment of the present invention, there is provided a method of producing a multi-layer ceramic electronic component, the method including: preparing a multi-layer sheet including laminated ceramic sheets and internal electrodes disposed between the ceramic sheets; cutting the multi-layer sheet to produce multi-layer chips each having side surfaces from which the internal electrodes are exposed; smoothing the side surfaces of the multi-layer chips; and providing side margins to the smoothed side surfaces of the multi-layer chips.

With this configuration, the side surfaces of the multi-layer chips, to which the side margins are provided, are previously smoothed. This eliminates micro irregularities of the side surfaces of the multi-layer chips, which are generated when the multi-layer sheet is cut, and thus the side margins adhere to the side surfaces of the multi-layer chips without gaps therebetween. As a result, a high joint strength of the side margins to the side surfaces of the multi-layer chips is obtained.

The providing side margins may include attaching a side margin sheet.

The side margin sheet may be punched out by the side surfaces of the multi-layer chips.

With this configuration, a high joint strength of the side margin sheet to the side surfaces of the multi-layer chips is obtained.

The side margin sheet may have a thickness of 25 μm or less.

With use of a thin side margin sheet, a high joint strength of the side margins to the side surfaces of the multi-layer chips is obtained. This is advantageous for miniaturization and increase in capacity of a multi-layer ceramic capacitor.

The smoothed side surfaces of the multi-layer chips may each have an irregularity height that is 20% or less of a thickness of the side margin sheet.

With this configuration, a high joint strength of the side margins to the multi-layer chips is more reliably obtained.

The side surfaces of each of the multi-layer chips may include a pair of side surfaces facing each other.

The smoothing the side surfaces of the multi-layer chips may include increasing parallelism of the pair of side surfaces. The parallelism of the pair of side surfaces smoothed may be 100% or less of a thickness of the side margin sheet.

With those configurations, the side margin sheet is attached to each of the side surfaces of the multi-layer chips by a uniform pressing force. Thus, the side margins are difficult to be peeled off from the side surfaces of the multi-layer chips.

The side surfaces of the multi-layer chips may be grinded to smooth the side surfaces.

The side surfaces of the multi-layer chips may be irradiated with laser to smooth the side surfaces.

The side surfaces of the multi-layer chips may be subjected to blasting to smooth the side surfaces.

With those configurations, a joint strength of the side margins to the side surfaces of the multi-layer chips can be effectively improved.

According to another embodiment of the present invention, there is provided a ceramic body for producing a multi-layer ceramic electronic component, the ceramic body being unsintered and including a multi-layer chip and side margins.

The multi-layer chip includes laminated ceramic layers, internal electrodes disposed between the ceramic layers, and side surfaces from which the internal electrodes are exposed.

The side margins are provided to the side surfaces of the multi-layer chip.

The side surfaces of the multi-layer chip each have an irregularity height that is 20% or less of a thickness of the side margins.

The side surfaces of the multi-layer chip may include a pair of side surfaces facing each other. Parallelism of the pair of side surfaces may be 100% or less of a thickness of the side margins.

The side margins may each have a thickness of 25 μm or less,

With this configuration, a joint strength of the side margins to the multi-layer chip can be more effectively improved.

According to another embodiment of the present invention, there is provided a multi-layer ceramic electronic component including a sintered body of the ceramic body described. above.

It is possbile to provide a multi-layer ceramic electronic component, a method of producing the multi-layer ceramic electronic component, and a ceramic body, which are capable of preventing side margins provided in a subsequent step from being peeled off.

These and other objects, features and advantages of the present invention will become more apparent in light of the following detailed description of embodiments thereof, as illustrated in the accompanying drawings.

### BRIEF DESCRIPTION OF THE DRAWINGS

FIG. 1 is a perspective view of a multi-layer ceramic capacitor according to an embodiment of the present invention;

FIG. 2 is a cross-sectional view of the multi-layer ceramic capacitor taken along the A-A′ line in FIG. 1;

FIG. 3 is a cross-sectional view of the multi-layer ceramic capacitor taken along the B-B′ line in FIG. 1;

FIG. 4 is a flowchart showing a method of producing the multi-layer ceramic capacitor;

FIGS. 5A, 5B, and 5C are plan views of ceramic sheets prepared in Step S01 of the production method;

FIG. 6 is a perspective view of a multi-layer sheet in Step S02 of the production method;

FIG. 7 is a plan view of the multi-layer sheet in Step S03 of the production method;

FIGS. 8A, 8B, and 8C are cross-sectional views of the multi-layer sheet in Step S03 of the production method;

FIGS. 9A and 9B are cross-sectional views of a multi-layer chip before Step S04 of the production method;

FIG. 10 is a perspective view of a smoothing apparatus used in Step S04 of the production method;

FIG. 11 is a perspective view of a smoothing apparatus used in Step S04 of the production method;

FIGS. 12A and 12B are cross-sectional views of a multi-layer chip after Step S04 of the production method;

FIGS. 13A and 13B are cross-sectional views of a multi-layer chip in Step S05 of the production method;

FIGS. 14A and 14B are cross-sectional views of multi-layer chips according to a reference example;

FIGS. 15A and 15B are cross-sectional views of a multi-layer chip in Step S06 of the production method;

FIG. 16 is a perspective view of an unsintered body after Step S07 of the production method;

FIGS. 17A and 17B are cross-sectional view of an unsintered multi-layer chip according to the production method; and

FIGS. 18A and 18B are perspective views of a smoothing apparatus according to another embodiment.

### DETAILED DESCRIPTION

Hereinafter, embodiments of the present invention will be described with reference to the drawings.

In the figures, an X axis, a Y axis, and a Z axis orthogonal to one another are shown as appropriate. The X axis, the Y axis, and the Z axis are common in all figures.

### 1. Configuration of Multi-Layer Ceramic Capacitor 10

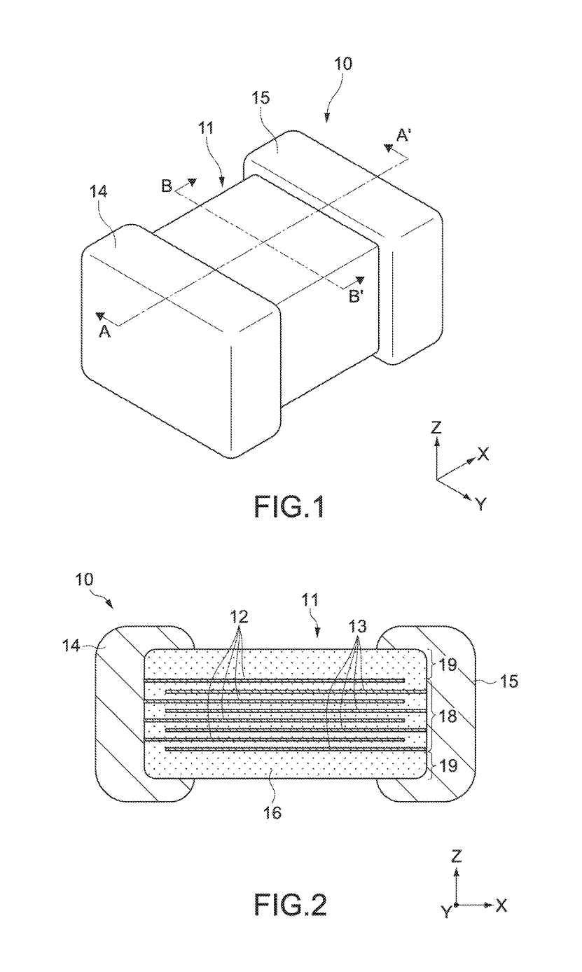

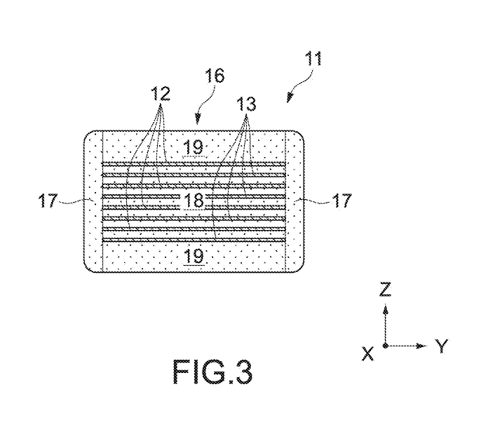

FIGS. 1 to 3 each show a multi-layer ceramic capacitor 10 according to an embodiment of the present invention. FIG. 1 is a perspective view of the multi-layer ceramic capacitor 10. FIG. 2 is a cross-sectional view of the multi-layer ceramic capacitor 10 taken along the A-A′ line in FIG. 1. FIG. 3 is a cross-sectional view of the multi-layer ceramic capacitor 10 taken along the B-B′ line in FIG. 1.

The multi-layer ceramic capacitor 10 includes a body 11, a first external electrode 14, and a second external electrode 15. The first external electrode 14 and the second external electrode 15 are apart from each other and face each other in an X-axis direction while sandwiching the body 11 therebetween.

The body 11 has two end surfaces oriented in the X-axis direction, two side surfaces oriented in a Y-axis direction, and two main surfaces oriented in a Z-axis direction. Ridges connecting the respective surfaces of the body 11 are chamfered. In the body 11, for example, a dimension in the X-axis direction can be set to 1.0 mm and dimensions in the Y- and Z-axis directions can be set to 0.5 mm.

It should be noted that the form of the body 11 is not limited to the form as described above. For example, the surfaces of the body 11 may be curved surfaces, and the body 11 may be rounded as a whole.

The first external electrode 14 and the second external electrode 15 cover both the end surfaces of the body 11 that are oriented in the X-axis direction, and extend to both the side surfaces oriented in the Y-axis direction and both the main surfaces oriented in the Z-axis direction, both the side surfaces and both the main surfaces being connected to both the end surfaces oriented in the X-axis direction. With this configuration, both of the first external electrode 14 and the second external electrode 15 have U-shaped cross sections in parallel with an X-Z plane and an X-Y plane.

The first external electrode 14 and the second external electrode 15 are each formed from a good conductor and function as terminals of the multi-layer ceramic capacitor 10. Examples of the good conductor forming the first and second external electrodes 14 and 15 include metal mainly containing nickel (Ni), copper (Cu), palladium (Pd), platinum (Pt), silver (Ag), gold (Au), or the like, and an alloy of those metals.

The first and second external electrodes 14 and 15 may have a single-layer structure or multi-layer structure.

The first and second external electrodes 14 and 15 of the multi-layer structure may be formed to have a double-layer structure including a base film and a surface film, or a three-layer structure including a base film, an intermediate film, and a surface film, for example.

The base film can be a baked film made of metal mainly containing nickel, copper, palladium, platinum, silver, gold, or the like, or an alloy of those metals, for example.

The intermediate film can be a plating film made of metal mainly containing platinum, palladium, gold, copper, nickel, or the like, or an alloy of those metals, for example.

The surface film can be a plating film made of metal mainly containing copper, tin, palladium, gold, zinc, or the like, or an alloy of those metals, for example.

The body 11 includes a multi-layer chip 16 and side margins 17.

The side margins 17 have a flat plate-like shape extending along the X-Z plane and cover both the side surfaces of the multi-layer chip 16 that are oriented in the Y-axis direction.

The multi-layer chip 16 includes a capacitance forming unit 18 and covers 19. The covers 19 have a flat plate-like shape extending along the X-Y plane and cover both main surfaces of the capacitance forming unit 18 that are oriented in the Z-axis direction.

The side margins 17 and the covers 19 have main functions of protecting the capacitance forming unit 18 and ensuring insulation properties of the periphery of the capacitance forming unit 18.

The capacitance forming unit 18 includes a plurality of first internal electrodes 12 and a plurality of second internal electrodes 13. The first internal electrodes 12 and the second internal electrodes 13 each have a sheet-like shape extending along the X-Y plane and are alternately disposed in the Z-axis direction. The first internal electrodes 12 are connected to the first external electrode 14 and are apart from the second external electrode 15. To the contrary, the second internal electrodes 13 are connected to the second external electrode 15 and are apart from the first external electrode 14.

The first internal electrodes 12 and the second internal electrodes 13 are each formed from a good conductor and function as internal electrodes of the multi-layer ceramic capacitor 10. Examples of the good conductor forming the first and second internal electrodes 12 and 13 include nickel (Ni), copper (Cu), palladium (Pd), platinum (Pt), silver (Ag), gold (Au), and a metal material including an alloy of those metals.

The capacitance forming unit 18 is made of dielectric ceramics. In the multi-layer ceramic capacitor 10, in order to increase capacitances of respective layers made of dielectric ceramics provided between the first and second internal electrodes 12 and 13, dielectric ceramics having a high dielectric constant is used as a material forming the capacitance forming unit 18. Examples of the dielectric ceramics having a high dielectric constant include a material having a Perovskite structure containing barium (Ba) and titanium (Ti), which is typified by barium titanate (BaTiO₃).

The side margins 17 and the covers 19 are also made of dielectric ceramics. A material of the side margins 17 and the covers 19 may be insulating ceramics, but use of a material similar to the material of the capacitance forming unit 18 leads to improvement in production efficiency and suppression of internal stress in the body 11.

With the configuration described above, when a voltage is applied between the first external electrode 14 and the second external electrode 15 in the multi-layer ceramic capacitor 10, a voltage is applied to the layers made of dielectric ceramic between the first and second internal electrodes 12 and 13. With this configuration, the multi-layer ceramic capacitor 10 stores charge corresponding to the voltage applied between the first external electrode 14 and the second external electrode 15.

It should be noted that the configuration of the multi-layer ceramic capacitor 10 is not limited to a specific configuration, and a well-known configuration can be used as appropriate in accordance with the size and performance expected for the multi-layer ceramic capacitor 10. For example, the number of first internal electrodes 12 and second internal electrodes 13 in the capacitance forming unit 18 can be determined as appropriate.

### 2. Method of Producing Multi-layer Ceramic Capacitor 10

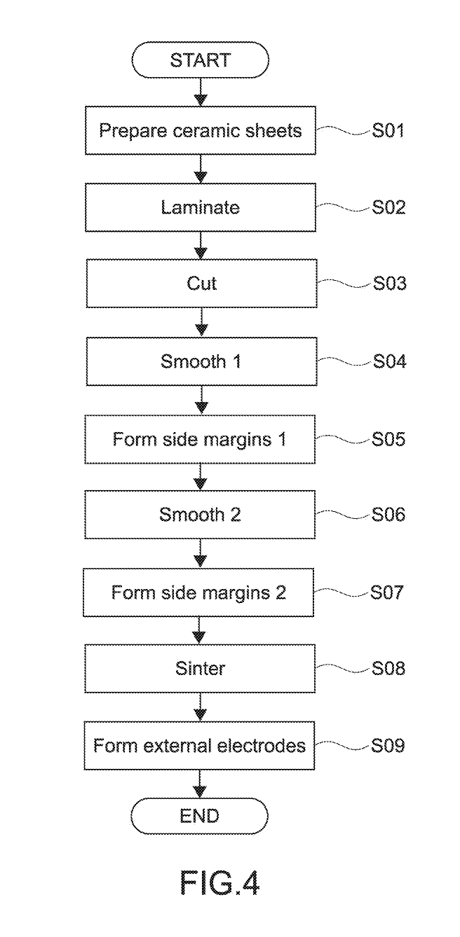

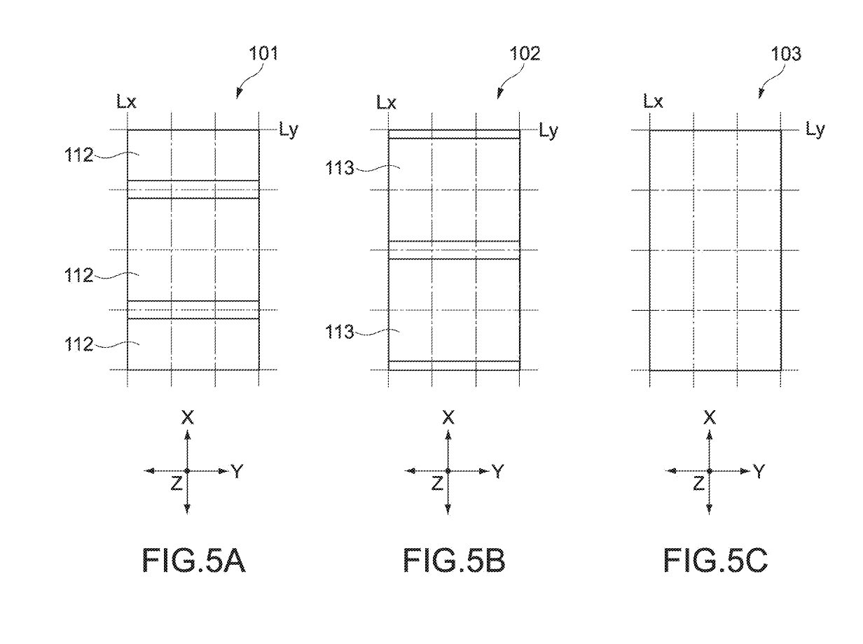

FIG. 4 is a flowchart showing a method of producing the multi-layer ceramic capacitor 10. FIGS. 5A to 17B are views showing a production process of the multi-layer ceramic capacitor 10. Hereinafter, the method of producing the multi-layer ceramic capacitor 10 will be described along FIG. 4 with reference to FIGS. 5A to 17B.

2.1 Step S01: Preparation of Ceramic Sheets

In Step S01, first ceramic sheets 101 and second ceramic sheets 102 for forming the capacitance forming unit 18, and third ceramic sheets 103 for forming the covers 19 are prepared.

FIGS. 5A, 5B, and 5C are plan views of the first, second, and third ceramic sheets 101, 102, and 103, respectively. FIG. 5A shows the first ceramic sheet 101, FIG. 5B shows the second ceramic sheet 102, and FIG. 5C shows the third ceramic sheet 103. The first, second, and third ceramic sheets 101, 102, and 103 are configured as unsintered dielectric green sheets and formed into a sheet shape by using a roll coater or a doctor blade, for example.

At the stage of Step S01, the first, second, and third ceramic sheets 101, 102, and 103 are not yet cut into the multi-layer ceramic capacitors 10. FIGS. 5A, 5B, and 5C each show cutting lines Lx and Ly used when the sheets are cut into the multi-layer ceramic capacitors 10. The cutting lines Lx are parallel to the X axis, and the cutting lines Ly are parallel to the Y axis.

As shown in FIGS. 5A, 5B, and 5C, unsintered first internal electrodes 112 corresponding to the first internal electrodes 12 are formed on the first ceramic sheet 101, and unsintered second internal electrodes 113 corresponding to the second internal electrodes 13 are formed on the second ceramic sheet 102. It should be noted that no internal electrodes are formed on the third ceramic sheet 103 corresponding to the covers 19.

The first and second internal electrodes 112 and 113 can be formed using any electrical conductive paste. For formation of the first and second internal electrodes 112 and 113 by use of an electrical conductive paste, a screen printing method or a gravure printing method can be used, for example.

Each of the first and second internal electrodes 112 and 113 is disposed over two areas and extends like a belt in the Y-axis direction. The two areas are adjacent to each other in the X-axis direction and divided by the cutting line Ly. The first internal electrodes 112 are shifted from the second internal electrodes 113 in the X-axis direction by one row including the areas divided by the cutting lines Ly. In other words, the cutting line Ly passing through the center of the first internal electrode 112 passes through an area between the second internal electrodes 113, and the cutting line Ly passing through the center of the second internal electrode 113 passes through an area between the first internal electrodes 112.

2.2 Step S02: Lamination

In Step S02, the first, second, and third ceramic sheets 101, 102, and 103 prepared in Step S01 are laminated, to produce a multi-layer sheet 104.

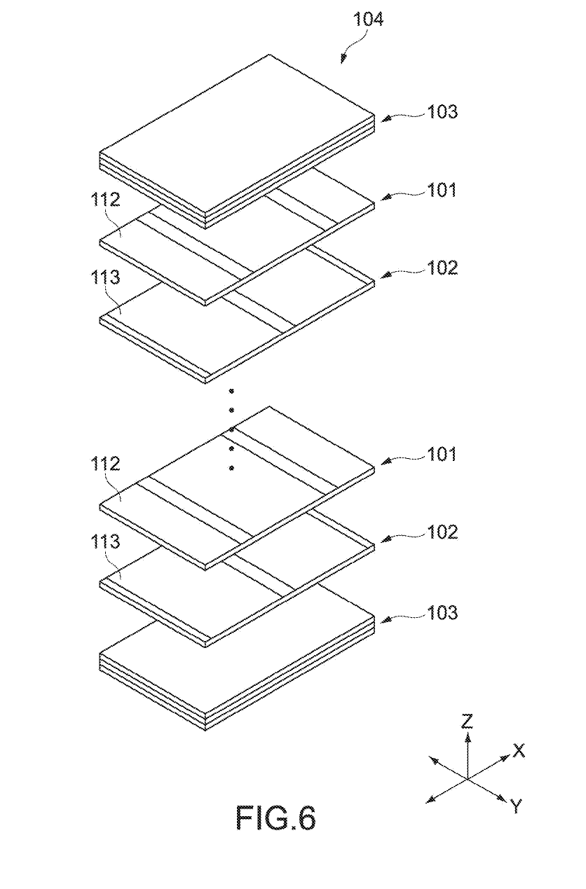

FIG. 6 is a perspective view of the multi-layer sheet 104 obtained in Step S02. For the purpose of description, FIG. 6 shows the first, second, and third ceramic sheets 101, 102, and 103 in an exploded manner. In an actual multi-layer sheet 104, however, the first, second, and third ceramic sheets 101, 102, and 103 are pressure-bonded by hydrostatic pressing, uniaxial pressing, or the like for integration. With this configuration, a high-density multi-layer sheet 104 is obtained.

In the multi-layer sheet 104, the first ceramic sheets 101 and the second ceramic sheets 102 that correspond to the capacitance forming unit 18 are alternately laminated in the Z-axis direction.

Further, in the multi-layer sheet 104, the third ceramic sheets 103 corresponding to the covers 19 are laminated on the uppermost and lowermost surfaces of the first and second ceramic sheets 101 and 102 alternately laminated in the Z-axis direction. It should be noted that in the example shown in FIG. 6, three third ceramic sheets 103 are laminated on each of the uppermost and lowermost surfaces of the laminated first and second ceramic sheets 101 and 102, but the number of third ceramic sheets 103 can be changed as appropriate.

2.3 Step S03: Cutting

In Step S03, the multi-layer sheet 104 obtained in Step S02 is cut to produce unsintered multi-layer chips 116. In Step S03, the multi-layer sheet 104 is cut by push-cutting.

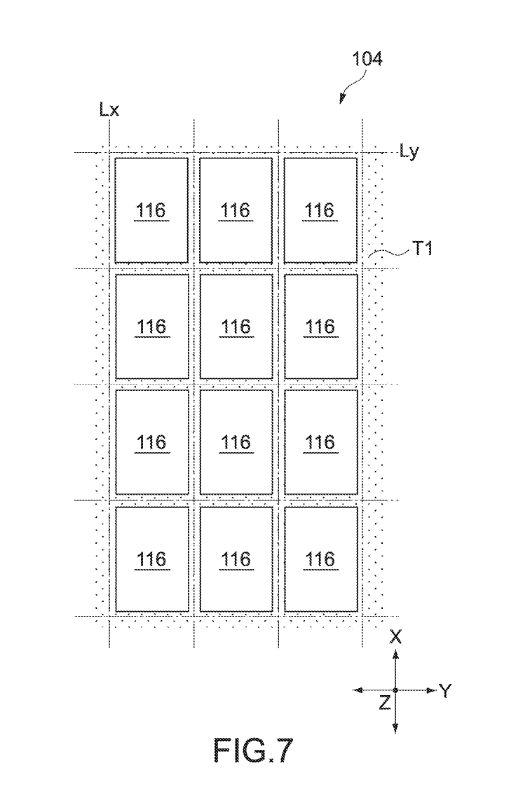

FIG. 7 is a plan view of the multi-layer sheet 104 after Step S03. The multi-layer sheet 104 is cut along the cutting lines Lx and Ly while being attached to a tape T1 as a holding member. With this configuration, the multi-layer sheet 104 is singulated, and the multi-layer chips 116 are obtained.

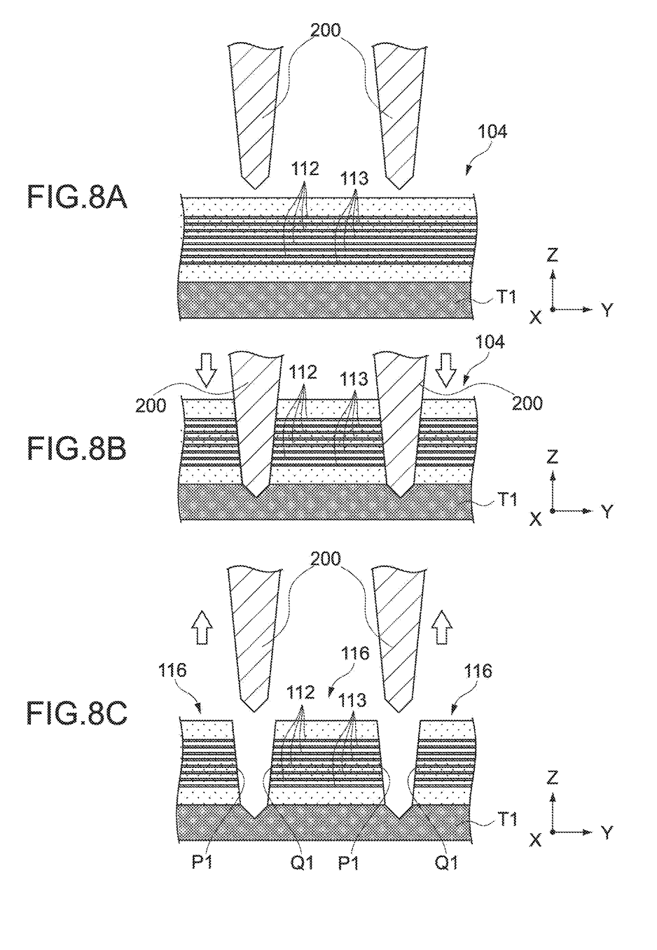

FIGS. 8A, 8B, and 8C are cross-sectional views of the multi-layer sheet 104 showing the process of Step S03. In Step S03, a cutting apparatus including a push-cutting blade 200 is used.

First, as shown in FIG. 8A, the push-cutting blade 200 oriented downward in the Z-axis direction is disposed above the multi-layer sheet 104 in the Z-axis direction.

Next, as shown in FIG. 8B, the push-cutting blade 200 is moved downward in the Z-axis direction until the push-cutting blade 200 reaches the tape T1, so that the multi-layer sheet 104 is cut. At that time, the push-cutting blade 200 does not penetrate the tape T1 such that the tape T1 is not cut.

Subsequently, as shown in FIG. 8C, the push-cutting blade 200 is moved upward in the Z-axis direction and pulled out of the multi-layer sheet 104.

With this configuration, the multi-layer sheet 104 is singulated into multi-layer chips 116. At that time, the tape T1 is not cut and connects the multi-layer chips 116. This makes it possible to collectively handle the multi-layer chips 116 in subsequent steps and to improve production efficiency.

Cut surfaces of the multi-layer sheet 104 that are formed in Step S03 are side surfaces P1 and Q1 and end surfaces of the multi-layer chips 116, the side surfaces P1 and Q1 being oriented in the Y-axis direction, the end surfaces being oriented in the X-axis direction.

As shown in FIGS. 8A, 8B, and 8C, the push-cutting blade 200 has a tapered shape with a width reduced downward in the Z-axis direction, because of easiness of pulling-out from the multi-layer sheet 104 after the cutting. As a result, the side surfaces P1 and Q1 of each multi-layer chip 116 obtained after Step S03 are tilted in such a manner that the side surfaces P1 and Q1 are apart from each other downward in the Z-axis direction. In other words, a cross section of the multi-layer chip 116 shown in FIG. 8C is a trapezoidal shape having a larger width downward in the Z-axis direction.

It should be noted that for the cutting of the multi-layer sheet 104, a technique using a blade different from the push-cutting blade may be used. For example, a rotary blade may be used. Furthermore, for the cutting of the multi-layer sheet 104, a technique using no blade may be used. For example, laser cutting or water jet cutting may be used.

In any case, in Step S03, the side surfaces P1 and Q1 of the multi-layer chip 116 may have an undesirable form when Steps S05 and S07 (formation of the side margins) are performed.

In this embodiment, by Steps S04 and S06 (smoothing) as described below, the side surfaces P1 and Q1 of the multi-layer chip 116 are processed to be side surfaces P2 and Q2 having a desirable form for Steps S05 and S07.

2.4 Step S04: Smoothing 1

In Step S04, the side surface P1 of the multi-layer chip 116 obtained in Step S03 is processed to form a side surface P2.

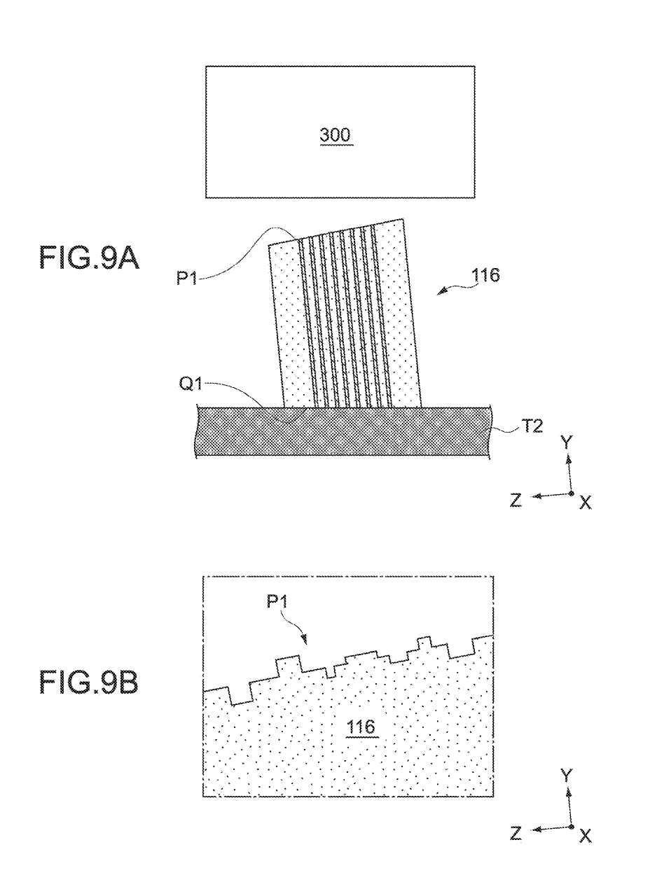

FIGS. 9A and 9B are views of the multi-layer chip 116 before Step S04. FIG. 9A is a cross-sectional view of the multi-layer chip 116. FIG. 9B is a partial cross-sectional view showing in an enlarged manner an area including the side surface P1 of the multi-layer chip 116.

As shown in FIG. 9B, the side surface P1 of the multi-layer chip 116 has micro irregularities formed in Step S03.

In Step S04, the side surface P1 of the multi-layer chip 116 is grinded, and a flat side surface P2 parallel to the side surface Q1 is thus formed. With this operation, the micro irregularities on the side surface P1 are removed, and a smooth side surface P2 is obtained.

As shown in FIG. 9A, in Step S04, the multi-layer chip 116 is bonded to a tape T2 from the tape T1, and the side surface Q1 is held by the tape T2. A smoothing apparatus 300 for smoothing the side surface P1 is disposed so as to face the side surface P1.

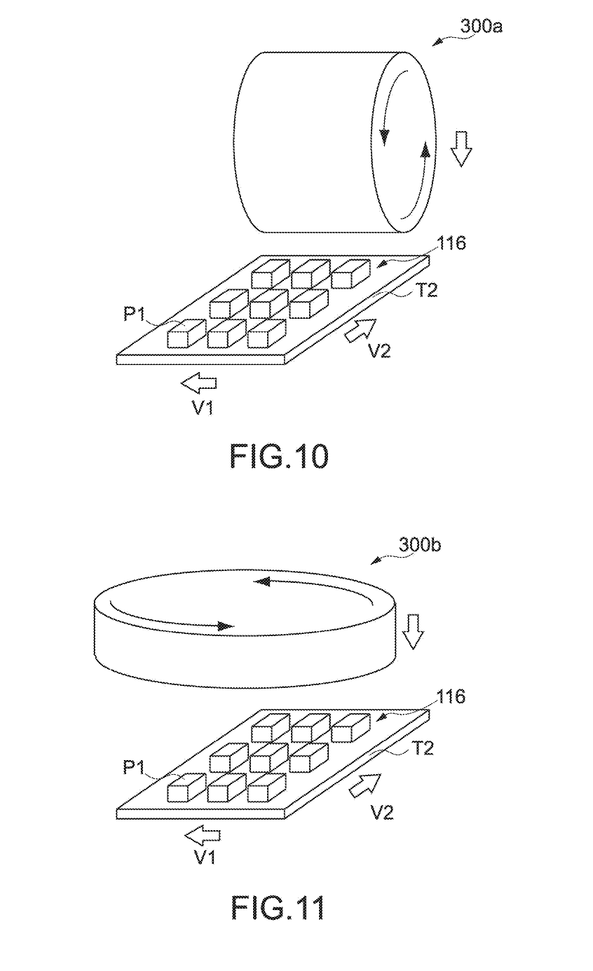

In this embodiment, a grinder 300a shown in FIG. 10 is used as the smoothing apparatus 300. In the example shown in FIG. 10, the multi-layer chips 116 are arrayed on the tape T2 and collectively subjected to Step S04. This improves production efficiency of the multi-layer ceramic capacitor 10.

The grinder 300a includes a circular cylinder having a central axis parallel to a surface of the tape T2. In the circular cylinder, the outer circumferential surface thereof is configured as a grinding surface. The grinder 300a rotates the circular cylinder about the central axis and brings the outer circumferential surface of the circular cylinder into contact with the side surfaces P1 of the multi-layer chips 116, to grind the side surfaces P1 of the multi-layer chips 116.

In this case, it is desirable to cool the multi-layer chips 116 by running water or the like such that temperatures of the multi-layer chips 116 are kept sufficiently lower than a transition point Tg of a binder.

The tape T2 is moved to slide as appropriate in a direction of the arrow V1 and in a direction of the arrow V2, so that the side surfaces P1 of all the multi-layer chips 116 arrayed on the tape T2 can be grinded. It should be noted that the circular cylinder of the grinder 300a may be moved instead of moving the tape T2.

Instead of the grinder 300a shown in FIG. 10, a grinder 300b shown in FIG. 11 can also be used as the smoothing apparatus 300.

The grinder 300b includes a disc body having a central axis perpendicular to the surface of the tape T2. In the disc body, a flat surface thereof is configured as a grinding surface. The grinder 300b rotates the disc body about the central axis and brings the flat surface of the disc body into contact with the side surfaces P1 of the multi-layer chips 116, to grind the side surfaces P1 of the multi-layer chips 116.

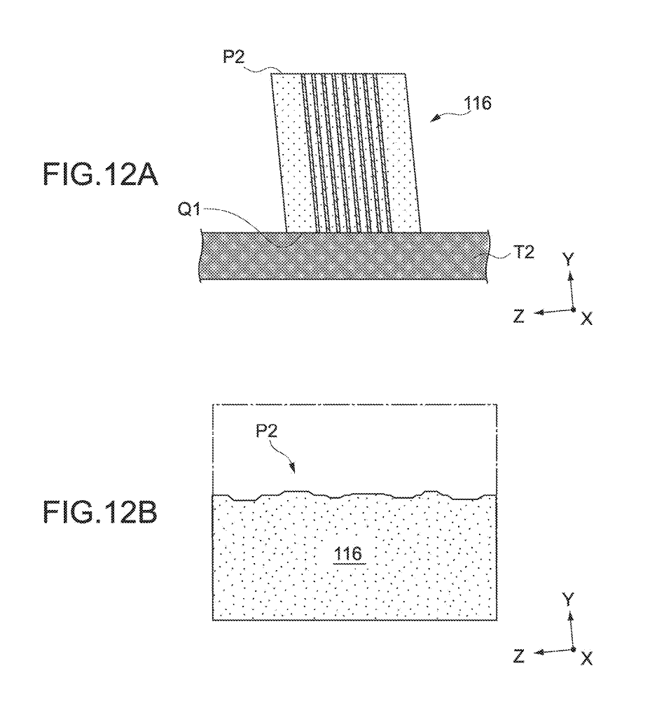

FIGS. 12A and 12B are views of the multi-layer chip 116 after Step S04. FIG. 12A is a cross-sectional view of the multi-layer chip 116. FIG. 12B is a partial cross-sectional view showing in an enlarged manner an area including the side surface P2 of the multi-layer chip 116.

In the multi-layer chip 116 after Step S04, the side surface P1 is grinded, and a flat side surface P2 parallel to the side surface Q1 is thus formed. Further, as shown in FIG. 12B, the side surface P2 of the multi-layer chip 116 is a smooth surface without micro irregularities.

The multi-layer chips 116 are then cleansed as needed, to remove grinding dust or the like adhering to the side surfaces P2 or the like.

2.5 Step S05: Formation of Side Margins 1

In Step S05, unsintered side margins 117 are formed on the side surfaces P2 of the multi-layer chips 116 obtained in Step S04.

In Step S05, a side margin sheet 117s for forming the side margins 117 is prepared. The side margin sheet 117s is configured as an unsintered dielectric green sheet, similar to the first, second, and third ceramic sheets 101, 102, and 103 prepared in Step S01. The side margin sheet 117s is formed into a sheet shape by using a roll coater or a doctor blade, for example.

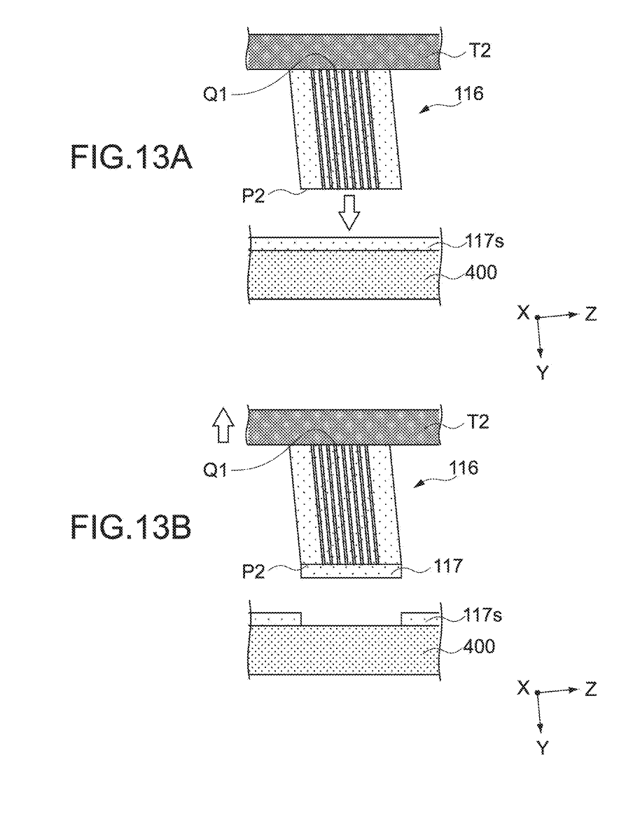

FIGS. 13A and 13B are cross-sectional views of the multi-layer chip 116 showing the process of Step S05.

First, as shown in FIG. 13A, the side margin sheet 117s is disposed on a flat plate-like elastic body 400. The multi-layer chip 116 is disposed such that the side surface P2 faces the side margin sheet 117s.

The side surface P2 of the multi-layer chip 116 is pressed against the side margin sheet 117s. The side margin sheet 117s is thus punched out by the side surface P2 of the multi-layer chip 116.

Subsequently, when the multi-layer chip 116 is pulled out of the side margin sheet 117s, as shown in FIG. 13B, only a side margin 117 that is punched out from the side margin sheet 117s and attached to the side surface P2 is separated from the elastic body 400 and remains on the multi-layer chip 116. Thus, a multi-layer chip 116 including the side margin 117 on the side surface P2 is obtained.

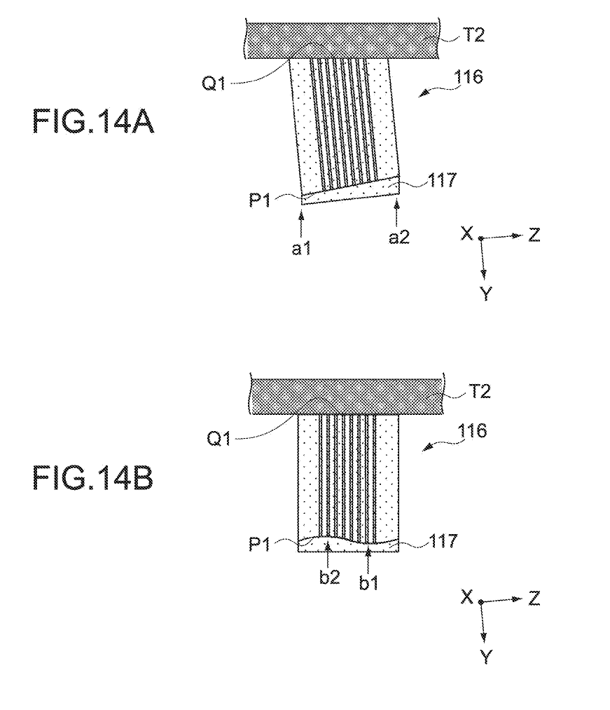

FIG. 14A is a cross-sectional view of the multi-layer chip 116 when the side margin 117 is formed on the side surface P1 of the multi-layer chip 116 in Step S05 without performing Step S04.

Since the side surface P1 of the multi-layer chip 116 has micro irregularities as shown in FIG. 9B, gaps are generated between the side margin 117 and the side surface P1 of the multi-layer chip 116.

Further, on the side surface P1 of the multi-layer chip 116 shown in FIG. 14A, an area a1 located downward in the Z-axis direction is projected, and an area a2 located upward in the Z-axis direction is recessed. As a result, a pressing force applied to the side margin sheet 117s from the area a1 is large, whereas a pressing force applied to the side margin sheet 117s from the area a2 is small.

As a result, unevenness in adhesion with the side margin 117 easily occurs on the side surface P1 of the multi-layer chip 116. Further, unevenness in density of the side margin 117 also easily occurs.

For those reasons, in the multi-layer chip 116 that is not subjected to Step S04, a sufficient joint strength of the side margin 117 to the side surface P1 may be difficult to obtain.

In particular, when a thin side margin sheet 117s is used in Step S05, a joint strength of the side margin 117 to the side surface P1 of the multi-layer chip 116 tends to be low. In other words, as the side margin sheet 117s is thinner, the side margin sheet 117s is more difficult to deform along the side surface P1 of the multi-layer chip 116. Thus, the side margin sheet 117s is difficult to adhere to the side surface P1 of the multi-layer chip 116.

In this regard, on the side surface P2 of the multi-layer chip 116 that is subjected to Step S04, the micro irregularities are removed and the side surface P2 is smooth. Thus, the side margin 117 can adhere to the side surface P2 of the multi-layer chip 116 along with the side surface P2 without gaps therebetween.

Further, on the side surface P2 of the multi-layer chip 116 that is parallel to the side surface Q1, there are no projecting areas nor recessed areas, and a pressing force applied to the side margin sheet 117s in Step S05 is made uniform. Thus, the side margin sheet 117s adheres to the entire area of the side surface P2 of the multi-layer chip 116 and has a uniform density.

With this configuration, in this embodiment, a side margin 117 having a high joint strength with respect to the side surface P2 of the multi-layer chip 116 and also having a uniform density can be obtained. Further, since gaps are difficult to be generated between the multi-layer chip 116 and the side margin 117, infiltration of a plating solution can be suppressed in Step S09 (formation of external electrodes) and the like, and a multi-layer ceramic capacitor 10 having high moisture resistance can be obtained.

Furthermore, as described above, the side margin sheet 117s is formed with use of a roll coater, a doctor blade, or the like. In those methods, as the side margin sheet 117s is made thinner, the side margin sheet 117s having a smoother surface is obtained. The side margin sheet 117s having a smooth surface particularly successfully adheres to the smooth side surface P2 of the multi-layer chip 116.

From those viewpoints, in this embodiment, a thin side margin sheet 117s having a thickness of 25 μm or less is used, so that a joint strength of the side margin 117 to the multi-layer chip 116 can be further effectively improved. This can prevent the side margin 117 from being peeled off and provide miniaturization and increase in capacity of the multi-layer ceramic capacitor 10.

Further, depending on the method of cutting the multi-layer sheet 104 in Step S03, as shown in FIG. 14B, the side surface P1 of the multi-layer chip 116 may have a corrugated form.

On the side surface P1 of the multi-layer chip 116 as described above, a convex area b1 and a concave area b2 are formed. As a result, a pressing force applied to the side margin sheet 117s from the convex area b1 is large, whereas a pressing force applied to the side margin sheet 117s from the concave area b2 is small.

Also in this case, the side surface P1 of the multi-layer chip 116 is grinded in Step S04 and a flat side surface P2 is formed. Thus, the pressing force applied to the side margin sheet 117s from the side surface P2 can be made uniform.

It should be noted that the method of forming the side margin 117 on the side surface P2 of the multi-layer chip 116 is not limited to the method of punching out the side margin sheet 117s.

For example, a side margin sheet 117s previously cut may be attached to the side surface P2 of the multi-layer chip 116.

Furthermore, without using the side margin sheet 117s, a ceramic paste may be applied to the side surface P2 of the multi-layer chip 116, and thus the side margin 117 may be formed. Examples of a method of applying a ceramic paste include a dip method. Also in such a case, the ceramic paste easily adheres to the side surface P2 of the multi-layer chip 116, the side surface P2 being smoothed and having no micro irregularities.

Consequently, also by the application of the ceramic paste, similar effects to those obtained when the side margin sheet 117s is attached can be obtained.

In other words, a high joint strength of the side margin 117 to the side surface P2 of the multi-layer chip 116 is obtained. Further, since gaps are difficult to be generated between the multi-layer chip 116 and the side margin 117, a multi-layer ceramic capacitor 10 having high moisture resistance is obtained. Furthermore, since the ceramic paste is difficult to have unevenness in thickness on the side surfaces P2 that is parallel to the side surface Q1, a side margin 117 having a uniform thickness is obtained.

2.6 Step S06: Smoothing 2

In Step S06, the side surface Q1 of the multi-layer chip 116 obtained in Step S05 is processed to form a side surface Q2.

More specifically, in Step S06, the side surface Q1 of the multi-layer chip 116 is grinded, and thus a flat side surface Q2 parallel to the side surface P2 is formed. In this embodiment, since the side surface Q1 of the multi-layer chip 116 is already parallel to the side surface P2, in Step S06, the side surface Q1 is uniformly grinded over the entire surface, to form a side surface Q2. This leads to removal of micro irregularities on the side surface Q1.

The smoothing of the side surface Q1 in Step S06 can be performed similarly to the smoothing of the side surface P1 in Step S04.

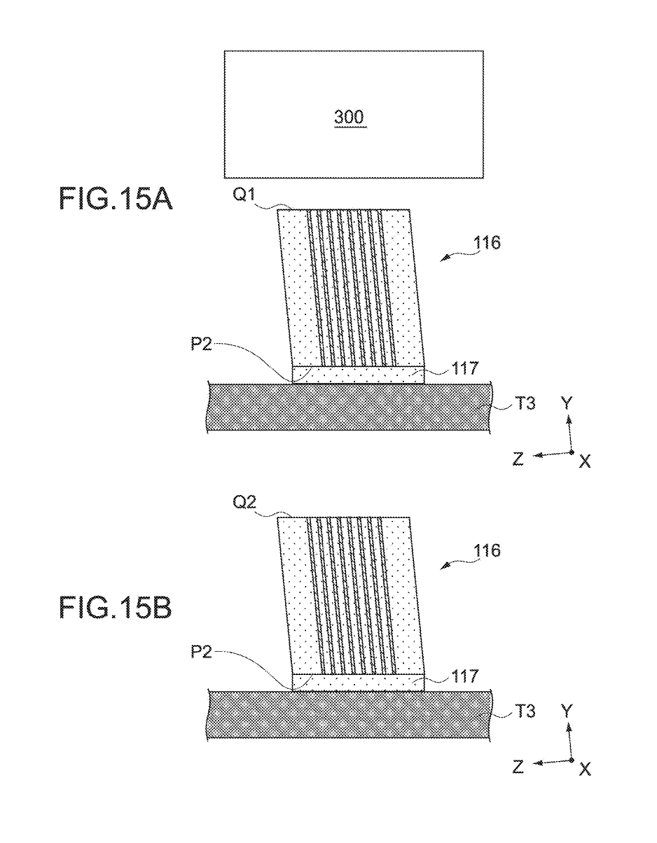

FIGS. 15A and 15B are cross-sectional views of the multi-layer chip 116 showing the process of Step S06.

As shown in FIG. 15A, in Step S06, the multi-layer chip 116 is bonded to a tape T3 from the tape T2, and the side margin 117 provided to the side surface P2 is held by the tape T3. With this configuration, the orientation of the multi-layer chip 116 is upside down from Step S04.

As a result, in Step S06, the side surface Q1, which is opposite to the side surface P1 processed in Step S04, can be processed by a similar way to Step S04. In Step S06, a smoothing apparatus 300 similar to that used in Step S04 can be used.

With this configuration, a side surface Q2 shown in FIG. 15B is formed on the multi-layer chip 116.

2.7 Step S07: Formation of Side Margins 2

In Step S07, unsintered side margins 117 are formed on the side surfaces Q2 of the multi-layer chips 116 obtained in Step S06. Formation of the side margins 117 on the side surfaces Q2 in Step S07 can be performed similarly to the formation of the side margins 117 on the side surfaces P2 in Step S05.

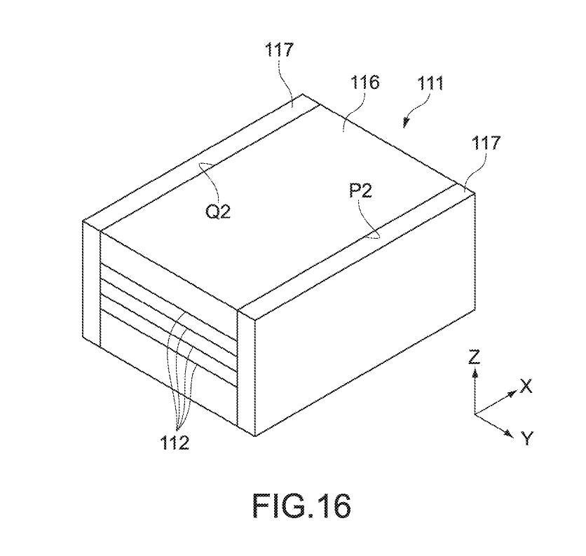

As described above, an unsintered body 111 as shown in FIG. 16 is obtained.

A form of the unsintered body 111 can be determined in accordance with a form of a sintered body 11. For example, in order to obtain the body 11 with the size of 1.0 mm×0.5 mm×0.5 mm, the unsintered body 11 with the size of 1.2 mm×0.6 mm×0.6 mm can be produced.

2.8 Step S08: Sintering

In Step S08, the unsintered body 111 obtained in Step S07 is sintered to produce the body 11 of the multi-layer ceramic capacitor 10 shown in FIGS. 1 to 3. Sintering can be performed in a reduction atmosphere or a low-oxygen partial pressure atmosphere, for example.

2.9 Step S09: Formation of External Electrodes

In Step S09, the first external electrode 14 and the second external electrode 15 are formed on the body 11 obtained in Step S08, to produce the multi-layer ceramic capacitor 10 shown in FIGS. 1 to 3.

In Step S09, first, an unsintered electrode material is applied so as to cover one of the end surfaces of the body 11 and then applied so as to cover the other one of the end surfaces of the body 11, both the end surfaces being oriented in the X-axis direction. The unsintered electrode materials applied to the body 11 are subjected to baking in a reduction atmosphere or a low-oxygen partial pressure atmosphere, for example, to form base films on the body 11. On the base films baked onto the body 11, intermediate films and surface films are formed by plating such as electrolytic plating. Thus, the first external electrode 14 and the second external electrode 15 are completed.

It should be noted that part of the processing in Step S09 described above may be performed before Step S08. For example, before Step S08, the unsintered electrode material may be applied to both the end surfaces of the unsintered body 111 that are oriented in the X-axis direction, and in Step S08, the unsintered body 111 may be sintered and, simultaneously, the unsintered electrode material may be baked to form base layers of the first external electrode 14 and the second external electrode 15.

### 3. Multi-Layer Chip 116 According to Another Embodiment

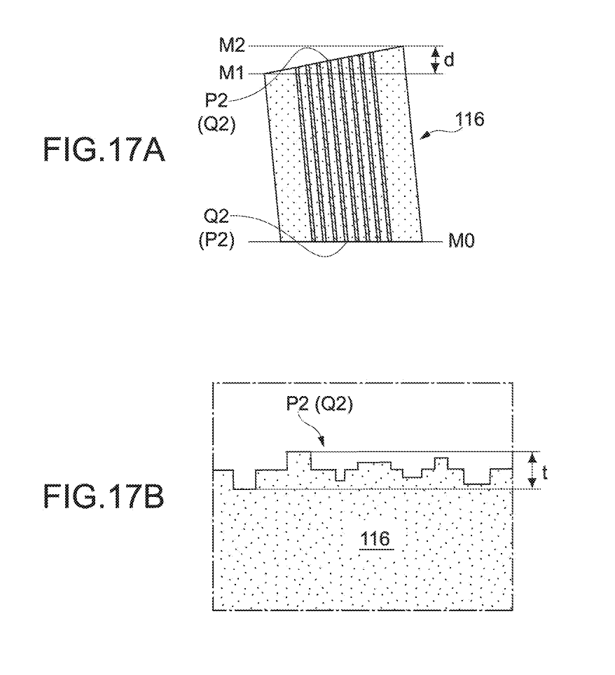

FIGS. 17A and 17B are cross-sectional views of an unsintered multi-layer chip 116 according to another embodiment. It should be noted that FIGS. 17A and 17B do not show the side margins 117 for the purpose of description.

In the embodiment described above, the surfaces P2 and Q2 of the multi-layer chip 116 are parallel to each other, but are not necessarily parallel to each other.

However, in order to improve a joint strength of the side margins 117 on the side surfaces P2 and Q2 of the multi-layer chip 116, parallelism of the side surfaces P2 and Q2 of the multi-layer chip 116 is desirably high.

Here, parallelism “d” of the side surfaces P2 and Q2 of the ulti-layer chip 116 will be described with reference to FIG. 17A.

First, the side surface Q2 is set as a reference surface M0. Among surfaces being parallel to the reference surface M0 and passing through the side surface P2, the closest surface from the reference surface M0 is set as a parallel surface M1, and the farthest surface from the reference surface M0 is set as a parallel surface M2. At that time, the parallelism “d” of the side surfaces P2 and Q2 is defined as a distance between the parallel surfaces M1 and M2.

As a matter of course, the side surface P2 may be used as the reference surface M0, and surfaces passing through the side surface Q2 may be used as the parallel surfaces M1 and M2.

Permissible parallelism “d” of the side surfaces P2 and Q2 for the multi-layer chip 116 can be determined in accordance with the thickness of the side margin sheet 117s used in Steps S05 and S07 or the like.

Specifically, the parallelism “d” of the side surfaces P2 and Q2 of the multi-layer chip 116 is desirably 100% or less of the thickness of the side margin sheet 117s. Further, the parallelism “d” of the side surfaces P2 and Q2 of the multi-layer chip 116 is further desirably 10 μm or less.

Further, as shown in FIG. 17B, some micro irregularities may remain on the side surfaces P2 and Q2.

However, in order to improve a joint strength of the side margins 117 to the side surfaces P2 and Q2 of the multi-layer chip 116, the side surfaces P2 and Q2 of the multi-layer chip 116 are desirably as smooth as possible.

Permissible smoothness of the side surfaces P2 and Q2 for the multi-layer chip 116 can be determined in accordance with the thickness of the side margin sheet 117s used in Steps S05 and S07 or the like.

Specifically, an irregularity height “t” of the side surface P2 or Q2 of the multi-layer chip 116 shown in FIG. 17B is desirably 20% or less of the thickness of the side margin sheet 117s. Further, surface roughness of the side surface P2 or Q2 of the multi-layer chip 116 is desirably 1 μm or less, and further desirably 300 nm or less.

It should be noted that according to JIS B 0601-1994, the irregularity height “t” described above can be defined as a maximum height Ry, and the surface roughness described above can be defined as a ten-point average roughness Rz. Further, in one example, the irregularity height “t” and the surface roughness can be obtained from surface shape data in which a rectangular measurement area having the size of 200 μm×200 μm in the side surface P2 or Q2 is measured at resolution of 512 pixels×512 pixels.

### 4. Smoothing Device 300 According to Another Embodiment

The smoothing apparatus 300 used in Steps S04 and S06 only needs to be capable of forming the side surfaces P2 and Q2 from the side surfaces P1 and Q1 of the multi-layer chip 116, and is not limited to the grinders 300a and 300b shown in FIGS. 10 and 11, respectively.

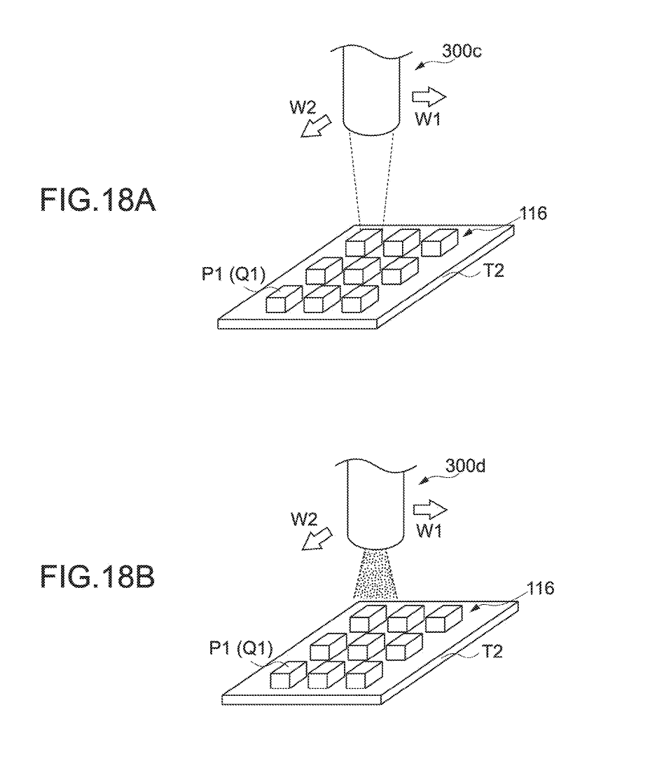

FIGS. 18A and 18B are views of a smoothing apparatus 300 according to another embodiment.

As shown in FIG. 18A, a laser irradiation apparatus 300c can be used as the smoothing apparatus 300. The laser irradiation apparatus 300c irradiates the side surfaces P1 and Q1 of the multi-layer chips 116 with laser, to form the side surfaces P2 and Q2.

The laser irradiation apparatus 300c is not limited to a specific configuration, but is desirably a pulse laser apparatus having a short pulse width. With this configuration, for example, generation of foreign substances accompanied by temperature rise of the side surfaces P1 and Q1 of the multi-layer chips 116 can be suppressed. Examples of the pulse laser apparatus having a short pulse width include a pica-second laser apparatus having a pulse width in a pico-second range and a femto-second laser apparatus having a pulse width in a femto-second range.

It should be noted that conditions such as a type of laser applied by the laser irradiation apparatus 300c, a spot diameter, intensity, time length of irradiation, and the number of times of irradiation can be determined as appropriate.

Examples of the type of laser include a YAG laser and a fiber laser.

Further, when the spot diameter of laser is small, the laser irradiation apparatus 300c performs scanning in a direction of the arrow W1 and in a direction of the arrow W2, so that the entire areas of the side surfaces P1 and Q1 of all the multi-layer chips 116 can be irradiated with laser. It should be noted that the tape T2 may be moved to slide instead of moving the laser irradiation apparatus 300c.

Further, in order to form the side surfaces P2 and Q2 of the multi-layer chips 116, a high energy beam other than laser can also be used. For example, when an electron beam is used as the high energy beam, a high-energy-beam irradiation apparatus including an electron gun can be used as the smoothing apparatus 300.

Furthermore, as shown in FIG. 18B, a blasting apparatus 300d can also be used as the smoothing apparatus 300. The blasting apparatus 300d sprays abrasive grains to the side surfaces P1 and Q1 of the multi-layer chips 116, to form the side surfaces P2 and Q2, The size of abrasive grains can be determined as appropriate and can be set to 3 μm or less, for example.

Blasting by the blasting apparatus 300d may be wet-blasting or dry-blasting (sandblasting, dry ice blasting, etc.). The abrasive grains used in wet-blasting or sandblasting can be selected as appropriate. For example, abrasive grains made of ceramics (alumina etc.), metal, glass, or plastic can be used. It should be noted that conditions of the blasting by the blasting apparatus 300d can be determined as appropriate.

In addition, the smoothing apparatus 300 may be configured to be capable of forming the side surfaces P2 and Q2 of the multi-layer chips 116 by a method other than the above method, such as etching.

Further, in Steps S04 and S06, the smoothing apparatus 300 is not necessarily used. Part or all of the processing by the smoothing apparatus 300 described above may be performed manually or performed with use of another apparatus. For example, instead of the grinders 300a and 300b, a flat polishing plate may be used.

### 5. Other Embodiments

While the embodiments of the present invention have been described, the present invention is not limited to the embodiments described above, and it should be appreciated that the present invention may be variously modified.

For example, when the side surfaces P2 and Q2 are formed from the side surfaces P1 and Q1 of the multi-layer chips 116 in Steps S04 and S06, micro irregularities are removed, and the parallelism of the side surfaces P2 and Q2 is increased. However, when the parallelism of the side surfaces P1 and Q1 falls within an allowable range, only removal of micro irregularities may be performed in Steps S04 and S06. Further, when the smoothness of the side surfaces P1 and Q1 falls within an allowable range, a side surface P2 parallel to the side surface Q1 may be formed in Step S04, and Step S06 may be omitted.

Further, the steps shown in FIG. 4 may be performed in different order as needed.

In one example, the unsintered multi-layer chips 116 obtained by the singulation in Step S03 may be sintered, and the sintered multi-layer chips 16 may be provided with the side margins 117. In this case, the sintered multi-layer chips 16 can be subjected to Steps S04 to S09 similar to the steps described above.

Furthermore, in the embodiments described above, the side surfaces P2 of the multi-layer chips 116 are formed in Step S04, and the side surfaces Q2 of the multi-layer chips 116 are formed in Step S06, However, the side surfaces P2 and Q2 of the multi-layer chips 116 may be formed at the same time. In this case, for example, with both the main surfaces of the multi-layer chips 116 oriented in the Z-axis direction being held, the side surfaces P1 and Q1 of the multi-layer chips 116 can be simultaneously irradiated with laser.

In addition, in the embodiments described above, the multi-layer ceramic capacitor has been described as an example of a multi-layer ceramic electronic component, but the present invention can be applied to any other multi-layer ceramic electronic components. Examples of such multi-layer ceramic electronic components include an inductor, a variable resistor, and a piezoelectric element.

What is claimed is:

1. A method of producing a multi-layer ceramic electronic component, the method comprising:
preparing a multi-layer sheet including
laminated ceramic sheets, and
internal electrodes disposed between the ceramic sheets;
cutting the multi-layer sheet to produce multi-layer chips each having side surfaces from which the internal electrodes are exposed;
smoothing the side surfaces of the multi-layer chips; and
providing side margins to the smoothed side surfaces of the multi-layer chips.

2. The method of producing a multi-layer ceramic electronic component according to claim 1, wherein
the providing side margins includes attaching a side margin sheet.

3. The method of producing a multi-layer ceramic electronic component according to claim 2, wherein
the side margin sheet is punched out by the side surfaces of the multi-layer chips.

4. The method of producing a multi-layer ceramic electronic component according to claim 2, wherein
the side margin sheet has a thickness of 25 μm or less.

5. The method of producing a multi-layer ceramic electronic component according to claim 2, wherein
the smoothed side surfaces of the multi-layer chips each have an irregularity height that is 20% or less of a thickness of the side margin sheet.

6. The method of producing a multi-layer ceramic electronic component according to claim 2, wherein
the side surfaces of each of the multi-layer chips include a pair of side surfaces facing each other, and
the smoothing the side surfaces of the multi-layer chips includes increasing parallelism of the pair of side surfaces.

7. The method of producing a multi-layer ceramic electronic component according to claim 6, wherein
the parallelism of the pair of side surfaces smoothed is 100% or less of a thickness of the side margin sheet.

8. The method of producing a multi-layer ceramic electronic component according to claim 1, wherein
the side surfaces of the multi-layer chips are grinded to smooth the side surfaces.

9. The method of producing a multi-layer ceramic electronic component according to claim 1, wherein
the side surfaces of the multi-layer chips are irradiated with laser to smooth the side surfaces.

10. The method of producing a multi-layer ceramic electronic component according to claim 1, wherein
the side surfaces of the multi-layer chips are subjected to blasting to smooth the side surfaces.

11. A ceramic body for producing a multi-layer ceramic electronic component, the ceramic body being unsintered and comprising:
a multi-layer chip including
laminated ceramic layers,
internal electrodes disposed between the ceramic layers, and
side surfaces from which the internal electrodes are exposed; and
side margins provided to the side surfaces of the multi-layer chip,
the side surfaces of the multi-layer chip each have an irregularity height that is 20% or less of a thickness of the side margins.

12. The ceramic body according to claim 11, wherein
the side surfaces of the multi-layer chip include a pair of side surfaces facing each other, and
parallelism of the pair of side surfaces is 100% or less of a thickness of the side margins.

13. The ceramic body according to claim 11, wherein
the side margins each have a thickness of 25 μm or less.

14. A multi-layer ceramic electronic component, comprising a sintered body of the ceramic body according to claim 11.
